(19) United States
(12) Patent Application Publication
(10) Pub. No.: US 2024/0201348 A1
(43) Pub. Date: Jun. 20, 2024

(54) SIGNAL PROCESSING DEVICE, ULTRASONIC SENSOR AND VEHICLE

(71) Applicant: ROHM CO., LTD., KYOTO (JP)

(72) Inventor: Koji Saito, KYOTO (JP)

(21) Appl. No.: 18/537,109

(22) Filed: Dec. 12, 2023

(30) Foreign Application Priority Data
Dec. 14, 2022 (JP) 2022-199765

(51) Int. Cl. G01S 7/52; B06B 1/06; G01S 15/931

(52) U.S. Cl. CPC G01S 7/52004; B06B 1/0644; G01S 15/931; B06B 2201/55

(57) ABSTRACT

The present disclosure provides a signal processing device. The signal processing device includes a receiving circuit, an envelope detection circuit, a differential amplifier circuit and a selection circuit. The receiving circuit is configured to generate a reflected wave signal based on a reflected wave from an object. The envelope detection circuit is configured to generate an envelope detection signal of the reflected wave signal. The differential amplifier circuit is configured to generate a differentially amplified signal of the envelope detection signal. The selection circuit is configured to select one of a first signal and a second signal. The first signal is the envelope detection signal or a delayed signal of the envelope detection signal. The second signal is the differentially amplified signal or a signal obtained using a difference between the envelope detection signal and the differentially amplified signal.

### TECHNICAL FIELD

The present disclosure relates to a signal processing device, an ultrasonic sensor and a vehicle.

### BACKGROUND

An ultrasonic sensor emits ultrasonic waves, measures a period of time from the emitted ultrasonic waves reach a target and return to the ultrasonic sensor, and uses the measured period of time to obtain a distance between the ultrasonic sensor and the target (for example, referring to patent publication 1).

In addition, there is a type of ultrasonic sensor that obtains characteristics such as the size of an object by measuring the size of a reflected wave signal. One method for measuring the size of a reflected wave signal is, for example, the method shown below. That is, as shown in FIG. 1, a threshold TH is set, and a time Tpw at which the reflected wave signal S1 exceeds the threshold TH is measured.

### PRIOR ART DOCUMENT

### Patent Publication

[Patent document 1] Japan Patent Publication No. 2014-35323

### BRIEF DESCRIPTION OF THE DRAWINGS

FIG. 1 is a diagram of a waveform a reflected wave signal.

FIG. 2 is a diagram of a path between an ultrasonic sensor and a target in a windless situation.

FIG. 3 is a diagram of a waveform a reflected wave signal in a windless situation.

FIG. 4 is a diagram of a path between an ultrasonic sensor and a target in a windy situation.

FIG. 5 is a diagram of a waveform a reflected wave signal in a windy situation.

FIG. 6 is a diagram of a configuration of an ultrasonic sensor according to an embodiment.

FIG. 7 is a circuit diagram of a configuration of a differential amplifier circuit of a first configuration example.

FIG. 8 is a diagram of characteristics of a lower clamping circuit.

FIG. 9 is a diagram of an envelope detection signal, a differentially amplified signal, and an output signal of a selection circuit of the first configuration example.

FIG. 10 is a circuit diagram of a configuration of a differential amplifier circuit of a second configuration example.

FIG. 11 is a diagram of an appearance of a vehicle.

FIG. 12 is a diagram of a configuration of a variation example of a differential amplifier circuit of the first configuration example.

FIG. 13 is a diagram of a configuration of another variation example of a differential amplifier circuit of the first configuration example.

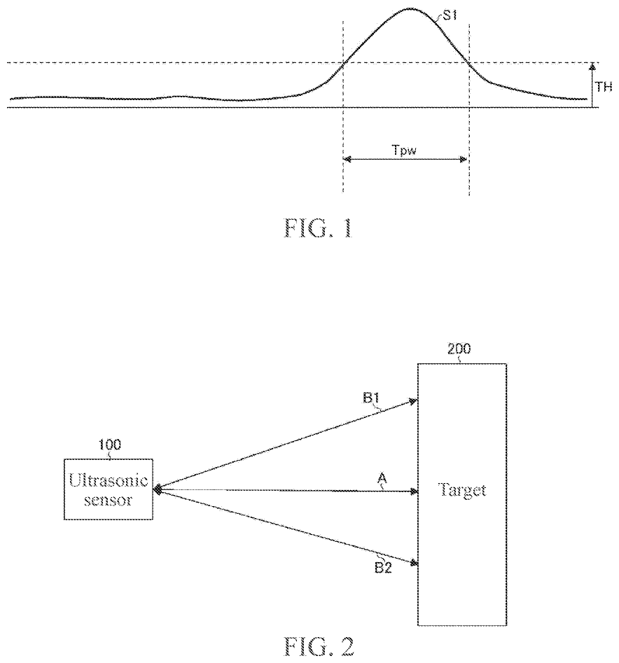

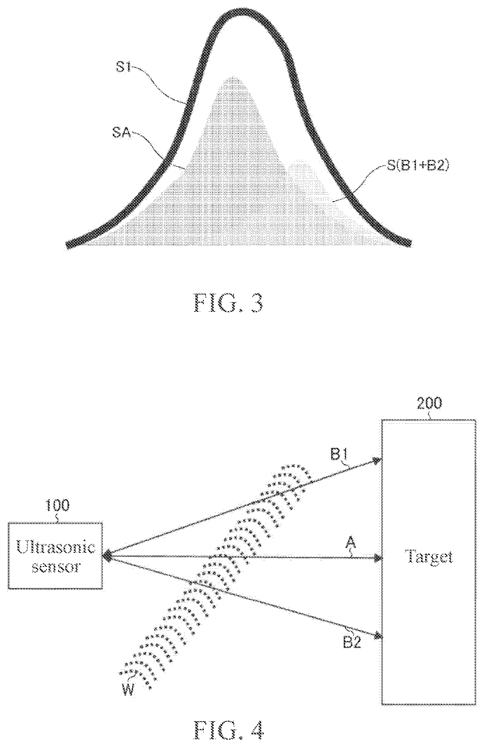

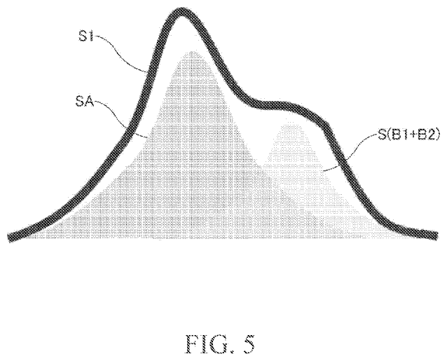

### DETAILED DESCRIPTION OF THE EMBODIMENTS

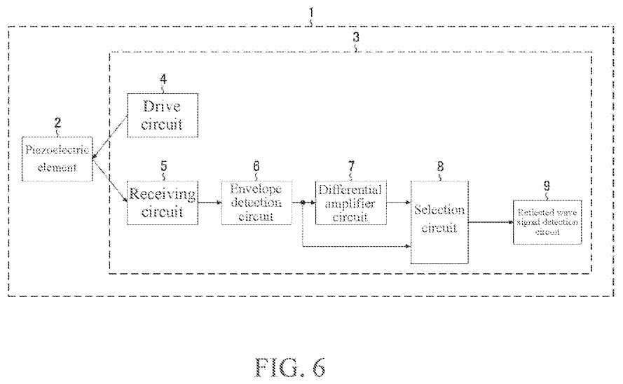

FIG. 6 shows a diagram of a configuration of an ultrasonic sensor 1 (to be referred to as an ultrasonic sensor 1 below) according to an embodiment. The ultrasonic sensor 1 includes a piezoelectric element 2 and a signal processing device 3.

The piezoelectric element 2 emits ultrasonic waves, and at the same time receives ultrasonic waves reflected by a target (reflected waves from an object). That is to say, the ultrasonic transceiving device 2 sends and receives ultrasonic waves. In addition, different from this embodiment, the ultrasonic sensor can also be configured to include a piezoelectric element exclusively for sending ultrasonic waves, and a piezoelectric element exclusively for receiving ultrasonic waves.

The signal processing device 3 processes a signal supplied to the piezoelectric element 2 and a signal received from the piezoelectric element 2. In addition, a transformer can be disposed between the piezoelectric element 2 and the signal processing device 3, or the transformer can be omitted.

The signal processing device 3 includes a drive circuit 4, a receiving circuit 5, an envelope detection circuit 6, a differential amplifier circuit 7, a selection circuit 8 and a reflection wave signal detection circuit 9.

The drive circuit 4 drives (vibrates) the piezoelectric element 2.

The receiving circuit 5 receives the signal output from the piezoelectric element 2, and generates a reflected wave signal based on reflected waves from an object.

The envelope detection circuit 6 generates an envelope detection signal which is a signal obtained by detecting an envelope of the reflected wave signal generated by the receiving circuit 5.

The differential amplifier circuit 7 generates a differentially amplified signal which is a signal obtained by amplifying the envelope detection signal generated by the envelope detection circuit 6.

The selection circuit 8 selects one between the envelope detection signal generated by the envelope detection circuit 6 and the differentially amplified signal generated by the differential amplifier circuit 7, and outputs the selected signal to the reflected wave signal detection circuit 9.

The reflected wave signal detection circuit 9 obtains a distance between the ultrasonic sensor 1 and the target based on a drive timing of the drive circuit 4 and the output signal of the selection circuit 8, and obtains characteristics such as the size of the target based on the output signal of the selection circuit 8.

With the selection circuit 8 selecting one between the envelope detection signal generated by the envelope detection circuit 6 and the differentially amplified signal generated by the differential amplifier circuit 7, influences of a rising waveform of the reflected wave signal can be minimized, while a falling waveform of the reflected wave signal can be altered. By altering the falling waveform of the reflected wave signal, a size variation in the reflected wave signal caused by influences of wind can be inhibited.

### First Configuration Example

In the first configuration example of the ultrasonic sensor 1, the envelope detection circuit 6 generates an envelope detection signal which is a signal obtained by detecting an upper envelope of the reflected wave signal generated by the receiving circuit 5. Moreover, the upper envelope refers to an envelope on the side with a higher voltage between two envelopes. On the other hand, a lower envelope refers to an envelope on the side with a lower voltage between two envelopes.

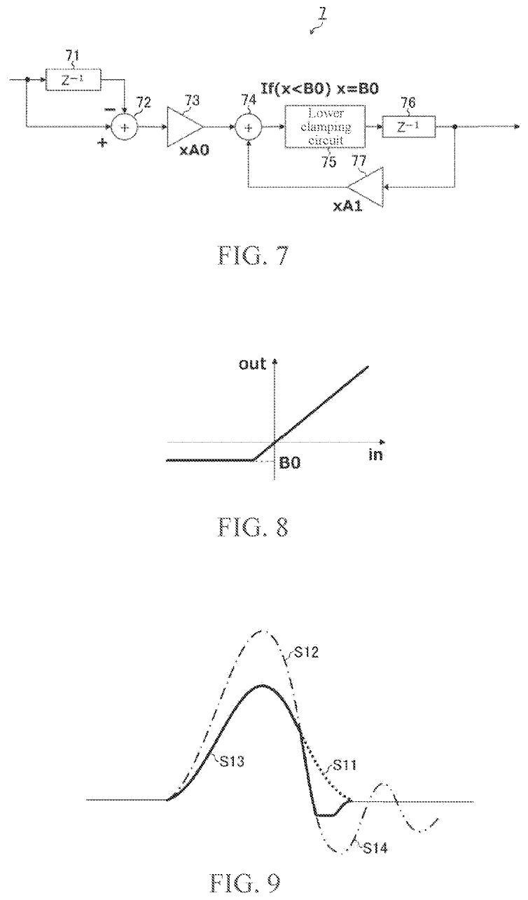

FIG. 7 shows a circuit diagram of a configuration of a differential amplifier circuit 7 of the first configuration example. The differential amplifier circuit 7 of the first configuration example includes a delayer 71, an adder-subtractor 72, an amplifier 73, an adder 74, a lower clamping circuit 75, a delayer 76 and an attenuator 77.

The envelope detection signal generated by the envelope detection circuit 6 is supplied to the delayer 71 and the adder-subtractor 72. The delayer 71 outputs a delayed signal of the envelope detection signal. The adder-subtractor 72 outputs a signal obtained by subtracting the output signal of the delayer 71 from the envelope detection signal.

The amplifier 73 outputs a signal obtained by multiplying the output signal of the adder-subtractor 72 by a gain A0, wherein the gain A0 is a value greater than 1.

The adder 74 outputs a signal obtained by adding an output signal of the attenuator 77 to the output signal of the amplifier 73.

The lower clamping circuit 75 has the characteristics shown in FIG. 8. The horizontal axis of the curve diagram shown in FIG. 8 represents the value of a signal (an input signal) supplied to the lower clamping circuit 75. The vertical axis of the curve diagram shown in FIG. 8 represents the value of a signal (an output signal) output from the lower clamping circuit 75. When an output signal X of the amplifier 73 is less than a predetermined value B0, the lower clamp circuit 75 clamps the output signal X of the amplifier 73 at the predetermined value B0, such that the output signal X of the amplifier 73 does not lower beyond the predetermined value B0, wherein predetermined value B0 is a value near 0. Thus, the differential amplifier circuit 7 of the first configuration example clamps the differentially amplified signal such that the differentially amplified signal does not lower than the predetermined value B0.

The delayer 76 outputs a delayed signal of the output signal of the lower clamping circuit 75. The output signal of the delayer 76 is supplied to the selection circuit 8 as the differentially amplified signal generated by the differential amplifier circuit 7. Moreover, the output signal of the delayer 76 is also supplied to the attenuator 77.

The attenuator 77 outputs a signal obtained by multiplying the output signal of the delayer 76 by a gain A1, wherein the gain A1 is a value less than 1.

In the first configuration example of the ultrasonic sensor 1, the selection circuit 8 selects the smaller one between the envelope detection signal generated by the envelope detection circuit 6 and the differentially amplified signal generated by the differential amplifier circuit 7.

FIG. 9 shows a diagram of an envelope detection signal S11, a differentially amplified signal S12 and an output signal S13 of a selection circuit of the first configuration example. It is known from FIG. 9 that, the differentially amplified signal S12 is selected during falling of the waveform. Accordingly, collapsing of the falling waveform due to influences of wind can be inhibited.

A variation example of the first configuration example can be a configuration without the lower clamping circuit 75. In a configuration without the lower clamping circuit 75, vibration such that in the differential amplifier signal S14 is generated, and the time for the reflected wave signal to converge to near 0 is increased. Thus, a configuration provided with the lower clamping circuit 75 as the first configuration example is more ideal.

### Second Configuration Example

In the second configuration example of the ultrasonic sensor 1, the envelope detection circuit 6 generates an envelope detection signal which is a signal obtained by detecting a lower envelope of the reflected wave signal generated by the receiving circuit 5.

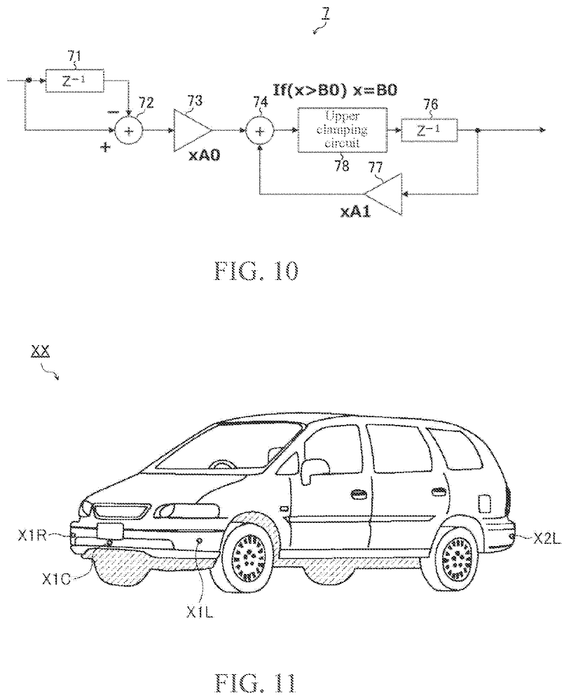

FIG. 10 shows a circuit diagram of a configuration of a differential amplifier circuit 7 of the second configuration example. The differential amplifier circuit 7 of the second configuration example is configured as, that is, wherein the lower clamping circuit 75 is removed from the differential amplifier circuit 7 of the first configuration example, and an upper clamping circuit 78 is provided in substitution for the lower clamping circuit 75.

When an output signal X of the amplifier 73 is greater than the predetermined value B0, the upper clamp circuit 78 clamps the output signal X of the amplifier 73 at the predetermined value B0, such that the output signal X of the amplifier 73 does not exceed the predetermined value B0, wherein predetermined value B0 is a value near 0. Thus, the differential amplifier circuit 7 of the second configuration example clamps the differentially amplified signal such that the differentially amplified signal does not exceed the predetermined value B0.

In the second configuration example of the ultrasonic sensor 1, the selection circuit 8 selects the greater one between the envelope detection signal generated by the envelope detection circuit 6 and the differentially amplified signal generated by the differential amplifier circuit 7.

A variation example of the second configuration example, similar to the variation example of the first configuration example, can be a configuration without the upper clamping circuit 78.

### <Sonar for Vehicle>

FIG. 11 shows a diagram of an appearance of a vehicle. On a front bumper of a vehicle XX, a front sonar X1 (L, R, C) is provided on each of left and right corners and a central part thereof. Moreover, on a rear bumper of the vehicle XX, a rear sonar X2 (L, R, C) is also provided on each of the left and right corners and the central part (the rear sonars X2R and X2C are not shown for better illustration of the drawing).

Thus, by mounting the front sonar X1 (L, R, C) and the rear sonar X2 (L, R, C) on the vehicle XX, an object (that is, an obstacle, other vehicles or a pedestrian) around the vehicle XX can be aimed to perform proximity sensing or distance measuring, hence assisting a driver to drive safely.

In addition, the front sonar X1 (L, R, C) and the rear sonar X2 (L, R, C) described above can be implemented by the ultrasonic sensor 1 or the variation example of the ultrasonic sensor 1 described above.

### OTHER

Various modifications may be made to the embodiments of the disclosure within the scope of the technical concept of the claims. The various embodiments given in the description above may be appropriately implemented in combination given that no contradictions are incurred. The embodiments above are only examples of possible embodiments of the disclosure, and the meanings of the terms of the disclosure or the constituting components are not limited to the meanings given in the embodiments above.

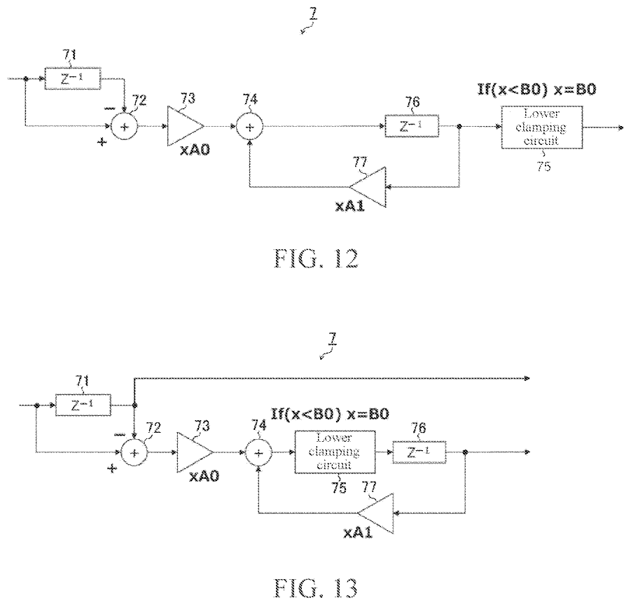

For example, in the first configuration example, the lower clamping circuit 75 is disposed on a front section of the delayer 76, but can also be disposed on a rear section of the delayer 76 as shown in FIG. 12.

Similarly, in the second configuration example, the upper clamping circuit 78 is disposed on a front section of the delayer 76, but can also be disposed on a rear section of the delayer 76.

Moreover, the amount of delay of the delayer 76 is minute in a way that influences of the amount delay upon the period of time from the ultrasonic waves reach a target and return to the ultrasonic sensor 1 can be considered 0. Thus, for example, a variation example of the first configuration example can also be implemented by a configuration in which the output signal of the delayer 76 is supplied to the exterior of the differential amplifier circuit 7 as shown in FIG. 13, thereby supplying the output signal of the delayer 76 to the selection circuit 8 in substitution for the envelope detection signal. In this case, the selection circuit 8 only needs to select the smaller one between the delayed signal of the envelope detection signal which is the output signal of the delayer 76 and the differentially amplified signal generated by the differential amplifier circuit 7.

Similarly, a variation example of the second configuration example can also be implemented by a configuration in which the output signal of the delayer 76 is supplied to the exterior of the differential amplifier circuit 7, thereby supplying the output signal of the delayer 76 to the selection circuit 8 in substitution for the envelope detection signal. In this case, the selection circuit 8 only needs to select the greater one between the delayed signal of the envelope detection signal which is the output signal of the delayer 76 and the differentially amplified signal generated by the differential amplifier circuit 7.

Moreover, in substitution for the differentially amplified signal generated by the differential amplifier circuit 7, a signal obtained from a difference between the envelope detection signal generated by the envelope detection circuit 6 and the differentially amplified signal generated by the differential amplifier circuit 7 is supplied to the selection circuit 8. The signal L obtained from the difference between the envelope detection signal generated by the envelope detection circuit 6 and the differentially amplified signal generated by the differential amplifier circuit 7 is used as long as, for example, the equation below using an envelope detection signal M and a differentially amplified signal N is satisfied. In the equation below, if K=1, this is the same as the first configuration example or the second configuration example. However, for example, K can also be set to be any desired value within a range between approximately 0.5 and 1.5.

$$\\ L = M - K * ( M - N )$$

In the first configuration example, only the upper envelope is detected in the envelope detection circuit 6; in the second configuration example, only the lower envelope is detected in the envelope detection circuit 6. However, both of the upper envelope and the lower envelope can be detected in the envelope detection circuit 6. For example, in a variation example of the first configuration example, the envelope detection circuit 6 only needs to generate a signal as the envelope detection signal, wherein the signal is a signal obtained by subtracting a signal obtained by detecting a lower envelope of the reflected wave signal generated by the receiving circuit 5 from a signal obtained by detecting an upper envelope of the reflected wave signal generated by the receiving circuit 5. For example, in a variation example of the second configuration example, the envelope detection circuit 6 only needs to generate a signal as the envelope detection signal, wherein the signal is a signal obtained by subtracting a signal obtained by detecting an upper envelope of the reflected wave signal generated by the receiving circuit 5 from a signal obtained by detecting a lower envelope of the reflected wave signal generated by the receiving circuit 5.

### NOTE

A note is attached to the present disclosure to show specific configuration examples of the embodiments above.

A signal processing device (3) of the present disclosure is configured as (a first configuration) comprising:

a receiving circuit (5), configured to generate a reflected wave signal based on a reflected wave from an object;

an envelope detection circuit (6), configured to generate an envelope detection signal of the reflected wave signal;

a differential amplifier circuit (7), configured to generate a differentially amplified signal of the envelope detection signal; and

a selection circuit (8), configured to select one of a first signal and a second signal, wherein

the first signal is the envelope detection signal or a delayed signal of the envelope detection signal, and the second signal is the differentially amplified signal or a signal obtained from a difference between the envelope detection signal and the differentially amplified signal.

The signal processing device of the first configuration can also be configured as (a second configuration), wherein the differential amplifier circuit is configured to clamp the differentially amplified signal.

The signal processing device of the first configuration can also be configured as (a third configuration), wherein the envelope detection signal is a signal obtained by detecting an upper envelope of the reflected wave signal, or a signal obtained by subtracting a signal obtained by detecting a lower envelope of the reflected wave signal from the signal obtained by detecting the upper envelope of the reflected wave signal.

The signal processing device of the third configuration can also be configured as (a fourth configuration), wherein the differential amplifier circuit is configured to clamp the differentially amplified signal, such that the differentially amplified signal does not lower than a predetermined value.

The signal processing device of the first configuration can also be configured as (a fifth configuration), wherein the envelope detection signal is a signal obtained by detecting an lower envelope of the reflected wave signal, or a signal obtained by subtracting a signal obtained by detecting an upper envelope of the reflected wave signal from the signal obtained by detecting the lower envelope of the reflected wave signal, and the selection circuit is configured to select a greater one of the first signal and the second signal.

The signal processing device of the fifth configuration can also be configured as (a sixth configuration), wherein the differential amplifier circuit is configured to clamp the differentially amplified signal, such that the differentially amplified signal does not exceed a predetermined value.

An ultrasonic sensor (1) of the present disclosure is configured as (a seventh configuration) comprising the signal processing device of any one of the first configuration to the sixth configuration, and a piezoelectric element configured to receive the reflected wave.

A vehicle (X) of the disclosure is configured as (an eighth configuration) comprising the ultrasonic sensor of the configuration above.

1. A signal processing device, comprising:
a receiving circuit, configured to generate a reflected wave signal based on a reflected wave from an object;
an envelope detection circuit, configured to generate an envelope detection signal of the reflected wave signal;
a differential amplifier circuit, configured to generate a differentially amplified signal of the envelope detection signal; and
a selection circuit, configured to select one of a first signal and a second signal, wherein
the first signal is the envelope detection signal or a delayed signal of the envelope detection signal, and
the second signal is the differentially amplified signal or a signal obtained from a difference between the envelope detection signal and the differentially amplified signal.

2. The signal processing device of claim 1, wherein the differential amplifier circuit is configured to clamp the differentially amplified signal.

3. The signal processing device of claim 1, wherein the envelope detection signal is
a signal obtained by detecting an upper envelope of the reflected wave signal, or
a signal obtained by subtracting a signal obtained by detecting a lower envelope of the reflected wave signal from the signal obtained by detecting the upper envelope of the reflected wave signal.

4. The signal processing device of claim 3, wherein the differential amplifier circuit is configured to clamp the differentially amplified signal, such that the differentially amplified signal does not lower than a predetermined value.

5. The signal processing device of claim 1, wherein the envelope detection signal is
a signal obtained by detecting an lower envelope of the reflected wave signal, or
a signal obtained by subtracting a signal obtained by detecting an upper envelope of the reflected wave signal from the signal obtained by detecting the lower envelope of the reflected wave signal, and
the selection circuit is configured to select a greater one of the first signal and the second signal.

6. The signal processing device of claim 5, wherein the differential amplifier circuit is configured to clamp the differentially amplified signal, such that the differentially amplified signal does not exceed a predetermined value.

7. An ultrasonic sensor, comprising:
the signal processing device of claim 1; and
a piezoelectric element configured to receive the reflected wave.

8. A vehicle comprising the ultrasonic sensor of claim 7.
